(19) United States
(12) Patent Application Publication
(10) Pub. No.: US 2010/0310120 A1
(43) Pub. Date: Dec. 9, 2010

(54) METHOD AND SYSTEM FOR TRACKING MOVING OBJECTS IN A SCENE

(76) Inventors: Charlie Keith, Bozeman, MT (US); Kevin Repasky, Bozeman, MT (US); John L. Carlsten, Bozeman, MT (US); Joseph A. Shaw, Bozeman, MT (US); Lee H. Spangler, Bozeman, MT (US)

Correspondence Address: COOLEY LLP;ATTN: Patent Group, Suite 1100, 777 - 6th Street, NW, WASHINGTON, DC, 20001, US

(21) Appl. No.: 11/963,042

(22) Filed: Dec. 21, 2007

(30) Foreign Application Priority Data
Nov. 5, 2005 (US) PCT/US2005/016170

(51) Int. Cl. G06K 9/00

(52) U.S. Cl. 382/103

(57) ABSTRACT

A method and system for tracking moving objects in a scene is described. One embodiment acquires a digital video signal corresponding to the scene; identifies in the digital video signal one or more candidate moving objects; locates at least one candidate moving object in the digital video signal subsequent to identification of the at least one candidate moving object; tracks candidate moving objects that, for at least a predetermined period after they have been identified, continue to be located in the digital video signal; assigns a score to each tracked candidate moving object in accordance with how long after passage of the predetermined period the tracked candidate moving object has continued to be located in the digital video signal; combines the respective scores of the tracked candidate moving objects to obtain an overall score for the scene; and indicates to a user whether the overall score satisfies a predetermined criterion.

### RELATED APPLICATIONS

Some of the subject matter of the instant application is related to commonly owned and assigned U.S. application Ser. No. 11/338,806, Attorney Docket No. MONT-031/01US, entitled “Optical Detection of Oscillating Targets Using Modulation of Scattered Laser Light.”

### STATEMENT REGARDING FEDERALLY SPONSORED RESEARCH OR DEVELOPMENT

This invention was made with government support under contract W909MY-06-C-0037 awarded by the U.S. Army. The U.S. government has certain rights in the invention.

### FIELD OF THE INVENTION

The present invention relates generally to digital image processing. More specifically, but not by way of limitation, the present invention relates to methods and systems for tracking moving objects in a scene.

### BACKGROUND OF THE INVENTION

One problem that arises in the field of digital image processing is that of tracking moving objects in a scene. In some applications, there is a need to track objects that pass through the scene relatively quickly. In other applications, there is a need to track relatively slow-moving objects that linger in the scene for a longer period.

One example of the latter type of application above is the tracking of insects such as honeybees in the detection of explosive materials that are used in making bombs. Properly trained honeybees can detect the vapor plumes given off by such explosive materials. The honeybees can be conditioned by adding trace amounts of the major chemical components of the explosive materials to a feeder. The honeybees are thus conditioned to associate the chemical smell with food. When the honeybees are released at a particular location (e.g., near a vehicle checkpoint), they will pause over an object (e.g., a vehicle) containing explosive materials as they forage for food.

Tracking objects such as foraging honeybees presents some challenges. First, insects such as honeybees are very small objects when viewed from a distance and may occupy only a few pixels in a captured digital video frame. Second, the scene often includes noise due to rustling vegetation or ephemeral glints of sunlight. Of course, there is also some low-level noise inherent in any digital imaging device used to capture the scene. Finally, the scene may at times also include moving objects not of interest (e.g., birds or airplanes) that pass through the scene relatively quickly.

It is thus apparent that there is a need in the art for an improved method and system for tracking moving objects in a scene.

### SUMMARY OF THE INVENTION

Illustrative embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents, and alternative constructions that fall within the spirit and scope of the invention as expressed in the claims.

The present invention can provide a method and system for tracking moving objects in a scene. One illustrative embodiment is a method for tracking moving objects in a scene, the method comprising acquiring a digital video signal corresponding to the scene; identifying in the digital video signal one or more candidate moving objects in the scene; locating at least one candidate moving object in the digital video signal subsequent to identification of the at least one candidate moving object; tracking candidate moving objects that, for at least a predetermined period after they have been identified, continue to be located in the digital video signal; assigning a score to each tracked candidate moving object in accordance with how long after passage of the predetermined period the tracked candidate moving object has continued to be located in the digital video signal; combining the respective scores of the tracked candidate moving objects to obtain an overall score for the scene; and indicating to a user whether the overall score satisfies a predetermined criterion.

Another illustrative embodiment of the invention is a system for tracking moving objects in a scene, the system comprising at least one processor and a memory containing a plurality of program instructions configured to cause the at least one processor to acquire a digital video signal corresponding to the scene; identify in the digital video signal one or more candidate moving objects in the scene; locate at least one candidate moving object in the digital video signal subsequent to identification of the at least one candidate moving object; track candidate moving objects that, for at least a predetermined period after they have been identified, continue to be located in the digital video signal; assign a score to each tracked candidate moving object in accordance with how long after passage of the predetermined period the tracked candidate moving object has continued to be located in the digital video signal; combine the respective scores of the tracked candidate moving objects to obtain an overall score for the scene; and indicate to a user whether the overall score satisfies a predetermined criterion.

These and other embodiments are described in further detail herein.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings, wherein:

FIG. 1 is a high-level block diagram of a system for tracking moving objects in a scene in accordance with an illustrative embodiment of the invention;

FIG. 2 is a functional block diagram of a computing device equipped with moving-object-tracking software for analyzing a digital video signal corresponding to a scene in accordance with an illustrative embodiment of the invention;

FIGS. 3A-3D are diagrams showing various ways of computing difference frames from a digital video signal in accordance with several illustrative embodiments of the invention;

FIGS. 4A and 4B are illustrations of difference frames to which a proximity filter has been applied in accordance with an illustrative embodiment of the invention;

FIG. 5 is a flowchart of a method for tracking moving objects in a scene in accordance with an illustrative embodiment of the invention;

FIG. 6A is a flowchart of a method for identifying one or more candidate moving objects in a digital video signal in accordance with an illustrative embodiment of the invention;

FIG. 6B is a flowchart of a method for identifying one or more candidate moving objects in a digital video signal in accordance with another illustrative embodiment of the invention; and

FIG. 7 is an illustration of a graph of an overall score of a moving-object-tracking system as a function of digital video frame number in accordance with an illustrative embodiment of the invention.

### DETAILED DESCRIPTION

In various illustrative embodiments of the invention, the difficulties of tracking a small moving object such as a honeybee in the presence of noise due to digital-imaging-device imperfections, rustling vegetation, and ephemeral glints of sunlight are overcome through appropriate filtering of a digital video signal corresponding to the scene. The digital video signal may be one captured in real time, or it may be a prerecorded digital video signal that is analyzed after the fact.

In one illustrative embodiment, a system for tracking moving objects in a scene identifies one or more candidate moving objects in the digital video signal. To separate objects of interest from noise, the system requires that a candidate moving object, once it has been identified, continue to be observed in the digital video signal for at least a minimum period (e.g., a for predetermined number of frames). For each candidate moving object that has been observed in the digital video signal for at least the minimum period, the system tracks that candidate moving object and assigns a score to it in accordance with how long after passage of the minimum period it continues to be observed in the digital video signal.

In this illustrative embodiment, the system combines the respective scores of the tracked candidate moving objects to obtain an overall score for the scene. The system indicates to a user whether the overall score satisfies a predetermined criterion. In some embodiments, the digital video signal is analyzed in real time to provide a real-time indication of whether the overall score satisfies the predetermined criterion.

In various illustrative embodiments of the invention, the filtering techniques applied to the digital video signal exploit known properties of the moving objects that are of interest. For example, in an application in which honeybees are tracked to detect explosive materials, assigning a score to tracked moving objects that increases with time as the tracked moving object continues to be located in the digital video signal favors objects such as foraging honeybees that tend to dwell within the scene for relatively long periods and disfavors objects such as airplanes or birds that may pass relatively quickly through the scene.

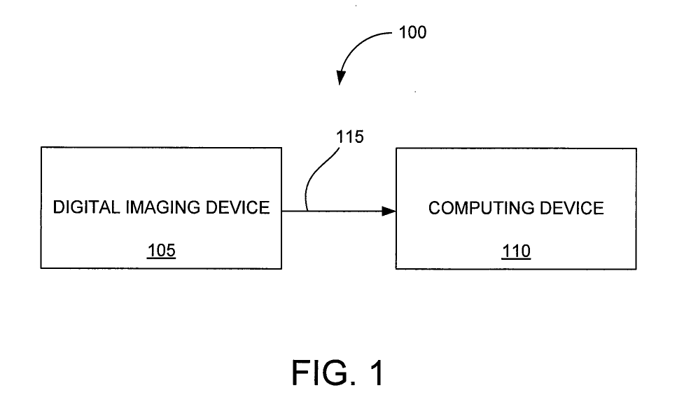

Referring now to the drawings, where like or similar elements are designated with identical reference numerals throughout the several views, and referring in particular to FIG. 1, it is a high-level block diagram of a system 100 for tracking moving objects in a scene in accordance with an illustrative embodiment of the invention. In the embodiment shown in FIG. 1, system 100 includes a digital imaging device 105 that is connected with a computing device 110 via input/output (I/O) channel 115. The communications protocol employed over I/O channel 115 may be any suitable protocol capable of handling high-speed digital video data. Examples include, without limitation, IEEE 1394 (the APPLE COMPUTER version of which is known as “FIREWIRE”) and universal serial bus (USB) 2.0.

In one illustrative embodiment that has been field tested, digital imaging device 105 is a PANASONIC AG-DVX100B digital camcorder interfaced via FIREWIRE with a DELL INSPIRON E1505 laptop computer. In this particular embodiment, the digital camcorder is configured for 30 full (non-interlaced) frames of video per second. The camcorder's autofocus feature is generally turned off during the tracking of small moving objects such as honeybees.

In other embodiments, system 100 does not include a dedicated digital imaging device 105 as shown in FIG. 1. Instead, computing device 110 processes prerecorded digital video data obtained from a separate digital imaging device and loaded onto a storage device, whether internal or external, to which computing device 110 has access. The captured digital video data (e.g., a digital video file) may be loaded onto the storage device via, for example, a local connection between the digital imaging device and the storage device, a removable computer-readable storage medium such as a Digital

Versatile Disc (DVD), or a data network.

One advantage of the embodiment shown in FIG. 1 is that computing device 110 can analyze the digital video signal received from digital imaging device 105 in real time and provide a real-time indication of whether objects of interest have been successfully tracked in the scene. Also, as will be explained further below, the embodiment shown in FIG. 1 can provide real-time visual monitoring of tracked objects to aid the user in aiming or repositioning digital imaging device 105.

Though digital imaging device 105 and computing device 110 are shown as separate devices in FIG. 1, in still other embodiments these components of system 100 may be integrated in a single self-contained device, if desired.

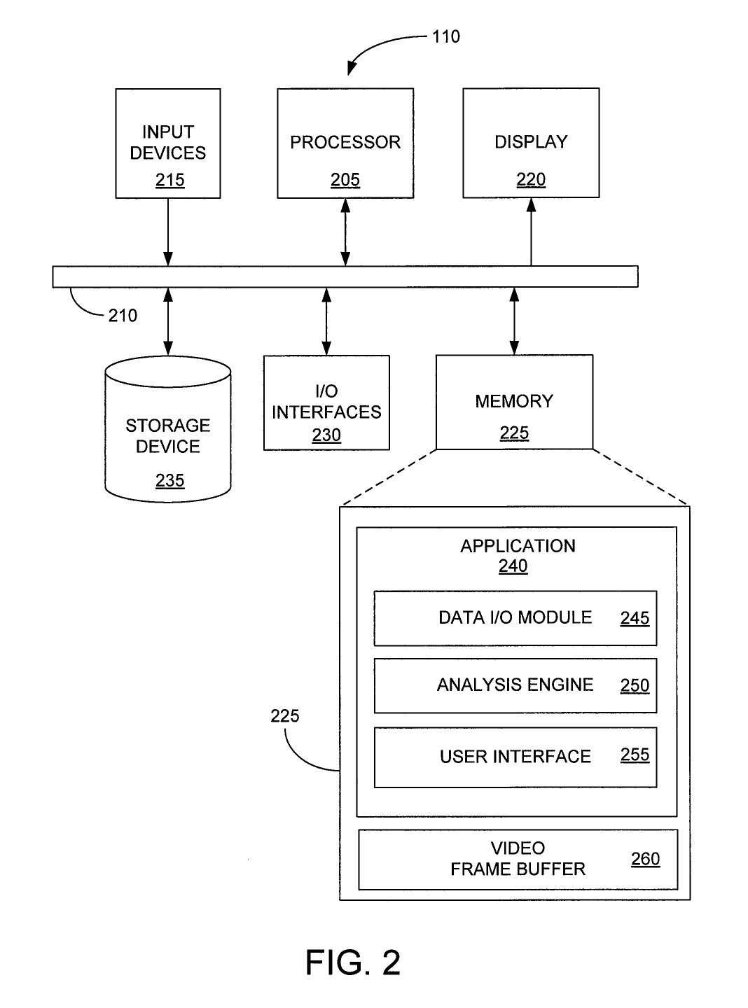

FIG. 2 is a functional block diagram of a computing device 110 equipped with a moving-object-tracking software application for analyzing a digital video signal corresponding to a scene in accordance with an illustrative embodiment of the invention. Computing device 110 may be, for example, a desktop computer, a laptop computer, a notebook computer, a computer embedded in a self-contained moving-object-tracking system, or any other suitable computing device.

In the embodiment shown in FIG. 2, processor 205 communicates over data bus 210 with input devices 215, display 220, memory 225, I/O interfaces 230, and storage device 235. Input devices 215 may include, e.g., a keyboard, a mouse or other pointing device, or other input devices for controlling the operation of computing device 110. I/O interfaces 230 may include, e.g., ports for IEEE 1394, USB 2.0, parallel data, or other protocols. Storage device 235 may be, e.g., a hard disk drive (HDD), optical storage device, flash-memory-based drive, or other storage device.

Memory 225 may include, e.g., random-access memory (RAM), read-only memory (ROM), flash memory, or a combination or sub-combination thereof. In the embodiment shown in FIG. 2, memory 225 includes, among other things, application 240 and an associated video frame buffer 260. Application 240 is configured to track moving objects in a digital video signal corresponding to a scene using digital image processing techniques that will be described in greater detail below. Video frame buffer 260 buffers frames of digital video that application 240 analyzes.

For convenience in this Detailed Description, application 240 has been divided into a set of functional modules: (1) data I/O module 245, (2) analysis engine 250, and (3) user interface 255.

Data I/O module 245 can be configured to handle both incoming and outgoing data. For example, data I/O module 245 can manage digital-image data received from a digital imaging device 105 or from a storage device containing a prerecorded digital video file. Data I/O module 245 can also control display 220 and perform other output-data-related functions.

Analysis engine 250 is configured to analyze a digital video signal corresponding to a scene of interest to identify and track moving objects in the scene. In doing so, analysis engine 250 employs various digital image processing techniques that will be described below.

User interface 255 manages interactions with a user of computing device 110. User interface 255 receives input commands from the user (e.g., via a keyboard or mouse) and, in conjunction with data I/O module 245, communicates appropriate prompts or other guidance to the user during the operation of computing device 110.

In other embodiments, the functional modules of application 240 described above may be subdivided or combined in ways other than that indicated in FIG. 2. Also, the functionality of application 240 running on computing device 110 may, in general, be implemented in software, firmware, custom hardware, or any combination or sub-combination thereof. In the embodiment shown in FIG. 2, the functionality of application 240 is implemented as a set of program instructions executable by processor 205 that, prior to being loaded into memory 225 for execution, resides on a computer-readable storage medium such as, without limitation, a magnetic disk, optical disc, or flash-memory device. For example, the program instructions of application 240 may be stored on storage device 235. The program instructions forming application 240 may be divided into multiple instruction segments or other functional units.

In identifying and tracking moving objects in a digital video signal, it is helpful to separate moving foreground objects from the mostly stationary background. One technique for performing this separation is generating a differential video signal by computing the difference between frames of the digital video signal. This technique may be termed “frame subtraction,” and a frame of the resulting differential video signal may be termed a “difference frame.” Regions of a difference frame that are black (zero or close to zero in intensity) indicate background regions that do not change from frame to frame. Bright areas in a difference frame indicate possible moving objects or noise (e.g., due to ephemeral glints of sunlight or rustling vegetation). Distinguishing the former from the latter involves further processing that will be described below.

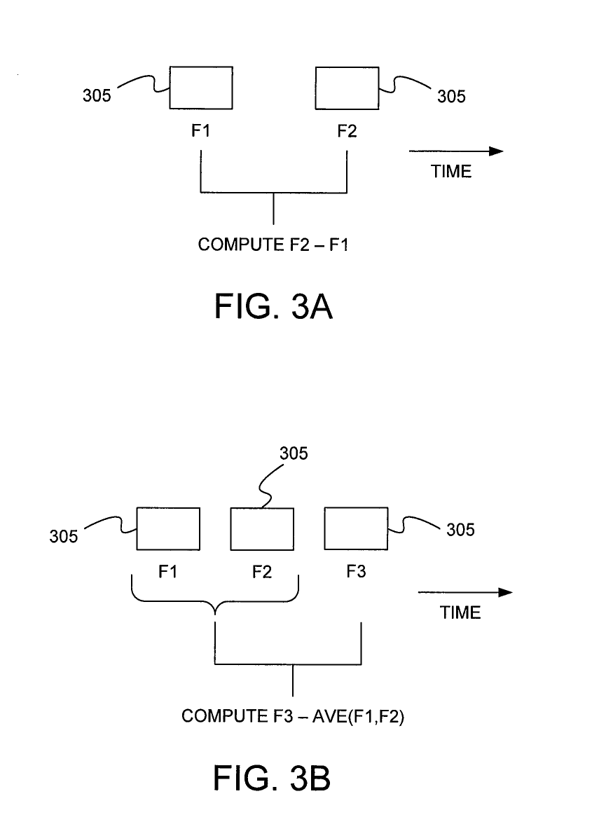

FIGS. 3A-3D are diagrams showing various ways of computing difference frames from a digital video signal to produce a differential video signal in accordance with several illustrative embodiments of the invention.

In the embodiment shown in FIG. 3A, a video frame 305 labeled “F1” corresponding to an earlier point in time is subtracted from a video frame 305 labeled “F2” corresponding to a later point in time to obtain a difference frame (not shown in FIG. 3A). Those skilled in the art will recognize that a difference frame computed as F1−F2 (later video frame 305 subtracted from earlier video frame 305) is also possible. In some embodiments, the video frames 305 F1 and F2 are consecutive video frames. In other embodiments, there may be intervening video frames between video frames 305 F1 and F2.

In the embodiment shown in FIG. 3B, the average of two earlier video frames 305 F1 and F2 is subtracted from a later video frame 305 F3 to obtain a difference frame (not shown in FIG. 3B). Again, the time relationships among the video frames 305 may be reversed. That is, the average of two later video frames 305 may instead be subtracted from an earlier video frame, if desired. As in the embodiment discussed in connection with FIG. 3A, video frames 305 F1, F2, and F3 in FIG. 3B may be consecutive video frames 305, or there may be intervening video frames between them.

In the embodiment shown in FIG. 3C, an average of four video frames 305 (F1, F2, F4, and F5) surrounding a video frame 305 F3 is subtracted from F3 to obtain a difference frame (not shown in FIG. 3C). This embodiment is particularly desirable from the standpoint of reducing speckle and noise in the difference frames.

In the embodiment shown in FIG. 3D, the approach discussed above in connection with FIG. 3C is generalized somewhat. In this embodiment, weighting factors 310 are applied to the surrounding video frames 305 F1, F2, F4, and F5 to produce a weighted average. The weighting factors shown in FIG. 3D, though arbitrary, illustrate that the weighting factors can be chosen, if desired, to favor video frames 305 F2 and F4, which are temporally closer to the “analysis frame” (video frame 305 F3 in FIG. 3D), over video frames 305 F1 and F5, which are temporally farther removed from the analysis frame F3.

Those skilled in the art will recognize that the various illustrative embodiments discussed above in connection with FIGS. 3A-3D involve buffering different numbers of video frames 305 in a frame buffer such as video frame buffer 260.

Once analysis engine 250 has produced a differential video signal from the digital video signal acquired via data I/O module 245, analysis engine 250 identifies and tracks candidate moving objects in the digital video signal. As discussed in further detail below, this may be accomplished by applying what may be termed a “proximity filter” to the differential video signal.

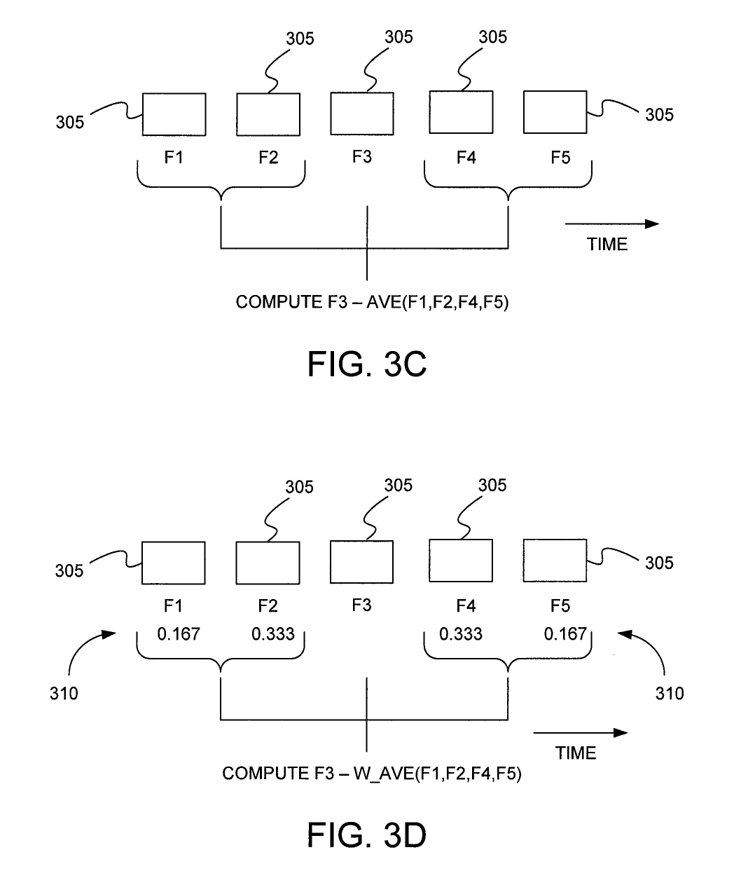

FIGS. 4A and 4B are illustrations of difference frames 405 to which a proximity filter has been applied in accordance with an illustrative embodiment of the invention. In FIG. 4A, a difference frame 405 (labeled “Difference Frame A”) includes a candidate moving object 410 made up of several pixels. Note that, in FIGS. 4A and 4B, the black (zero or near-zero) background region has been shown as white and the relatively bright pixels making up candidate moving object 410 have been shown as black for simplicity and clarity in the context of patent drawings. When analysis engine 250 first encounters the illustrated group of relatively bright pixels in difference frame 405 “A,” it identifies the group of pixels as a candidate moving object 410.

FIG. 4B is an illustration of a difference frame 405 “B” produced later in time than difference frame 405 “A” in FIG. 4A. In this embodiment, analysis engine 250 examines a neighborhood 415 surrounding the position 420 (shown in dashed outline in FIG. 4B) at which candidate moving object 410 was located in prior difference frame 405 “A.”

In the example of FIG. 4B, analysis engine 250 has located candidate moving object 410 at its new position within the neighborhood 415. The circular boundary for neighborhood 415 indicated in FIG. 4B is merely illustrative. Any suitable shape (square, hexagonal, etc.) for neighborhood 415 may be employed, depending on the particular application. Those skilled in the art will recognize that the size of neighborhood 415 may be adjusted to optimize the performance of the proximity filter for a particular application.

The technique illustrated in FIG. 4B may be termed a “proximity filter” because analysis engine 250 searches, in a subsequent difference frame 405, for a previously identified candidate moving object 410 within a portion of the subsequent difference frame that is in relatively close proximity to the position at which the candidate moving object 410 was last observed in a prior difference frame 405.

When analysis engine 250 has successfully located a particular candidate moving object 410 for a sufficiently long period to warrant a conclusion that it is not a false positive (e.g., speckle or noise), analysis engine 250 begins tracking and scoring the candidate moving object 410. For example, in one embodiment, analysis engine 250 begins tracking and scoring a candidate moving object 410 after it has been located in ten successive difference frames 405. For each difference frame 405 thereafter in which the particular candidate moving object 410 is observed, a numerical score associated with that candidate moving object 410 is incremented. Thus, the longer a given candidate moving object 410 continues to be observed in the digital video signal, the higher its score becomes. Such a scoring system favors relatively slow-moving objects that dwell for a relatively long time in the scene (e.g., foraging honeybees).

The above-described characteristic can be accentuated by increasing the score of a tracked candidate moving object 410 non-linearly with time. For example, in one embodiment, the score of a tracked candidate moving object 410 is incremented by one for each of the first ten difference frames 405 in which it is found once analysis engine 250 has begun tracking the candidate moving object 410, by four for each of the next ten difference frames 405 in which it is found, by eight for each of the next ten difference frames 405 in which it is found, etc. The particular values by which the score is incremented and the division of time into periods including ten difference frames 405 mentioned above are merely illustrative. In general, in such an embodiment, the rate at which the score of a tracked candidate moving object 410 is incremented is increased with time as the tracked candidate moving object 410 continues to be located in the differential video signal.

As mentioned above, the individual scores of the tracked candidate moving objects 410 can be combined into an overall score for the scene, and analysis engine 250 can be configured to test the overall score against a predetermined criterion. In one illustrative embodiment, analysis engine 250 compares the overall score with a predetermined threshold, and the predetermined threshold's being exceeded indicates that there is likely to be at least one foraging honeybee in the scene. User interface 255 may report to the user whether the predetermined criterion has been satisfied (e.g., whether or not the predetermined threshold has been exceeded). In reporting the status to the user, user interface 255 may employ a visual indicator such as text and/or graphics on display 220 or a light; an audible indicator such as a beep, tone, or recorded spoken message; or both.

In embodiments in which the satisfying of the predetermined criterion is the exceeding of a threshold, the threshold may be chosen in accordance with the particular application and environment and may be user adjustable. For example, on a given day, the threshold may be adjusted relative to a measured background score of the scene at the particular location where the system is to be used. Tracked candidate moving objects 410 corresponding to foraging honeybees or other moving objects of interest in the scene will then “stand out” from the established background score by exceeding an appropriately chosen threshold above the “floor” background score.

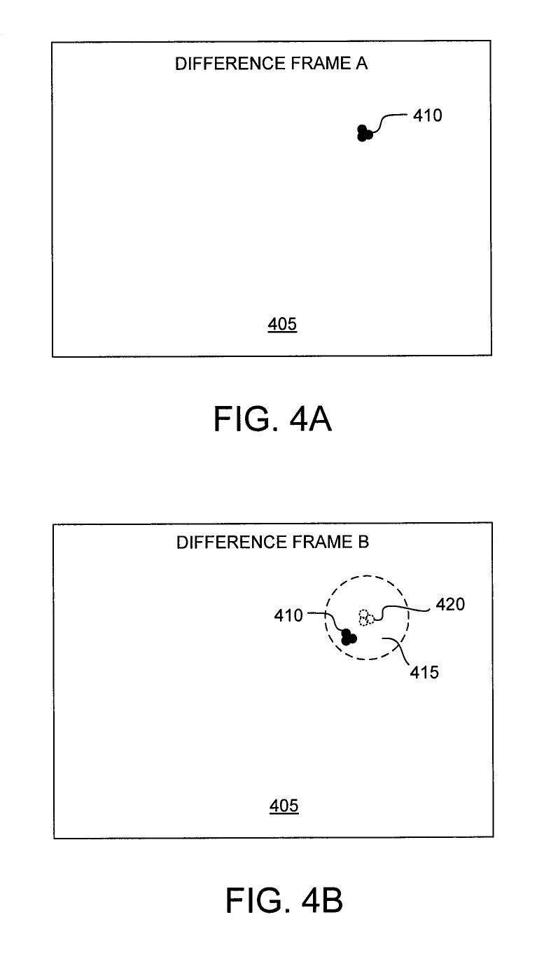

FIG. 5 is a flowchart of a method for tracking moving objects in a scene in accordance with an illustrative embodiment of the invention. At 505, data I/O module 245 acquires a digital video signal corresponding to the scene. As explained above, data I/O module 245 may acquire the digital video signal in real time from a connected digital imaging device 105, or it may acquire the digital video signal from a prerecorded digital video file residing on storage device 235 or from some other source. At 510, analysis engine 250 identifies one or more candidate moving objects 410 in the digital video signal. As explained above, analysis engine 250 may do so by applying a proximity filter to a differential video signal made up of difference frames 405.

At 515, analysis engine 250 locates at least one candidate moving object 410 in the digital video signal subsequent to its initial identification at 510. At 520, analysis engine 250 tracks any candidate moving objects 410 that, for at least a predetermined period after their initial identification, continue to be observed in the digital video signal. At 525, analysis engine 250 assigns a score to each tracked candidate moving object 410 in accordance with how long the tracked candidate moving object 410 has continued to be located in the digital video signal beyond passage of the predetermined period.

At 530, analysis engine 250 combines (e.g., totals) the respective scores of the tracked candidate moving objects 410 to obtain an overall score for the scene. At 535, user interface 255 indicates to a user whether the overall score satisfies a predetermined criterion. The process terminates at 540.

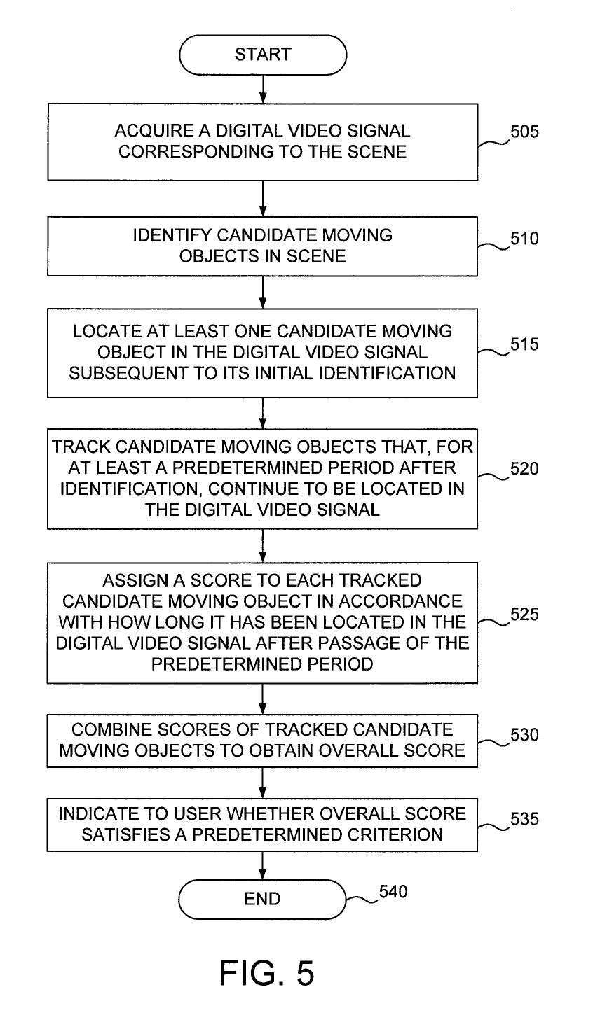

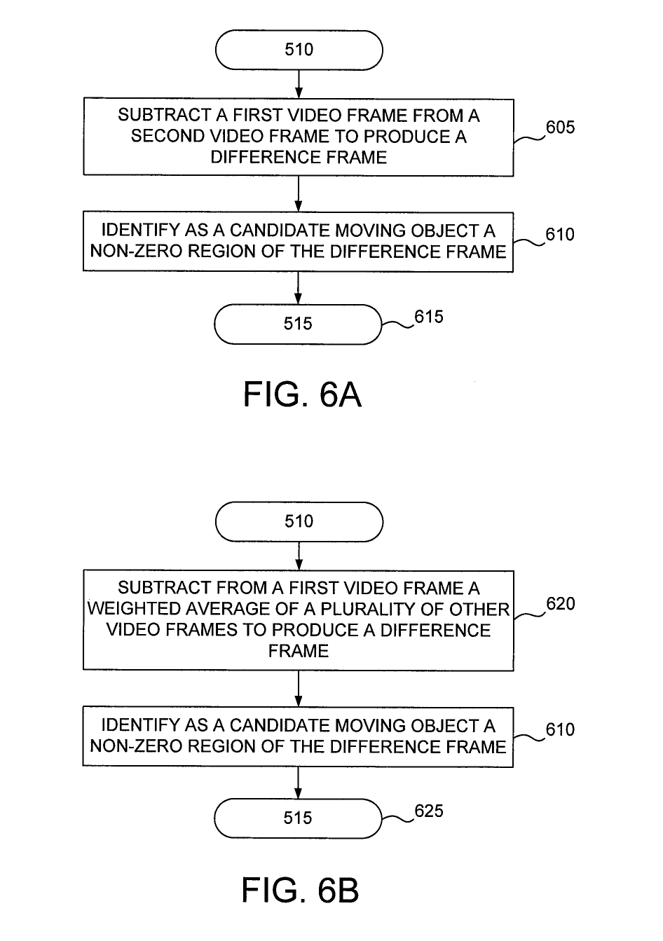

FIG. 6A is a flowchart of a method for identifying one or more candidate moving objects in a digital video signal in accordance with an illustrative embodiment of the invention. In FIG. 6A, the process is entered after Block 510 in FIG. 5. At 605, analysis engine 250 subtracts a first video frame 305 from a second video frame 305 to produce a difference frame 405. At 610, analysis engine 250 identifies as a candidate moving object 410 a non-zero region of the difference frame 405. The process then proceeds to Block 515 in FIG. 5.

FIG. 6B is a flowchart of a method for identifying one or more candidate moving objects in a digital video signal in accordance with another illustrative embodiment of the invention. The process is entered after Block 510 in FIG. 5. At 620, analysis engine 250 subtracts from a first video frame 305 a weighted average of a plurality of other video frames 305 to produce a difference frame 405. Here, the term “weighted average” is intended to be general and covers the special case in which the averaged plurality of video frames 305 are weighted equally. Again, at 610, analysis engine 250 identifies as a candidate moving object 410 a non-zero region of the difference frame 405. The process then proceeds to Block 515 in FIG. 5.

In one embodiment, computing device 110 outputs the differential video signal produced by analysis engine 250 to display 220 in approximately real time (depending on how many video frames 305 are required for the computation of each difference frame 405, there is some latency in the differential video signal relative to the digital video signal due to buffering of video frames 305). Displaying the differential video signal can aid the user in aiming or repositioning digital imaging device 105. To further aid the user in aiming or repositioning the digital imaging device 105, a low-intensity version of the overall scene can be combined with the differential video signal in a single view. For example, each pixel of the digital video signal corresponding to the scene can be divided by a predetermined non-zero value greater than unity, and this reduced-intensity view of the scene and the differential video signal can be superimposed on display 220.

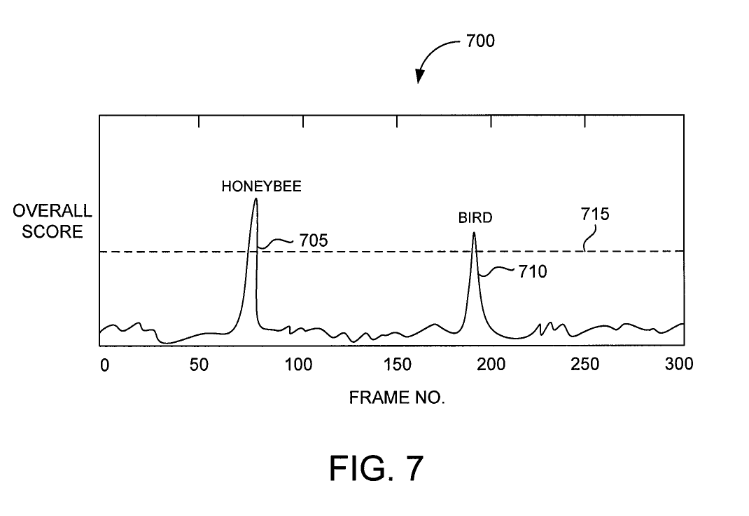

FIG. 7 is an illustration of a graph 700 of the overall score of a moving-object-tracking system as a function of digital video frame number in accordance with an illustrative embodiment of the invention. Optionally, system 100 (or a moving-object-tracking system that includes only computing device 110) may plot a graph such as that shown in FIG. 7 to facilitate further analysis of the gathered data. In the simplified example shown in FIG. 7, two peaks in the overall score are shown, one corresponding to a foraging honeybee (705), the other corresponding to a circling bird (710). In the example shown in FIG. 7, the overall score is compared with a threshold 715. Many variations in the format of such a graph are possible, depending on the particular application.

In one particular application alluded to above, a system based on the principles of the invention is used to track foraging honeybees at a vehicle checkpoint to detect vehicles containing explosive devices. In such an application, the number of foraging honeybees tracked at any one time may be as few as one to three. Many other applications of the principles of the invention are possible. In general, the techniques described above are particularly effective for tracking relatively slow-moving objects that remain within a scene for a relatively long period. Examples of such moving objects other than foraging honeybees include other kinds of insects, circling birds, weather balloons, etc.

In some applications, it may be advantageous to deploy a system based on the principles of the instant invention separately but simultaneously with a system based on the techniques described in commonly owned and assigned U.S. application Ser. No. 11/338,806, Attorney Docket No. MONT-031/01US, filed on Jan. 25, 2006.

In conclusion, the present invention provides, among other things, a method and system for tracking moving objects in a scene. Those skilled in the art can readily recognize that numerous variations and substitutions may be made in the invention, its use, and its configuration to achieve substantially the same results as achieved by the embodiments described herein. Accordingly, there is no intention to limit the invention to the disclosed illustrative forms. Many variations, modifications, and alternative constructions fall within the scope and spirit of the disclosed invention as expressed in the claims.

What is claimed is:

1. A method for tracking moving objects in a scene, the method comprising:
acquiring a digital video signal corresponding to the scene;
identifying in the digital video signal one or more candidate moving objects in the scene;
locating at least one candidate moving object in the digital video signal subsequent to identification of the at least one candidate moving object;
tracking candidate moving objects that, for at least a predetermined period after they have been identified, continue to be located in the digital video signal;
assigning a score to each tracked candidate moving object in accordance with how long after passage of the predetermined period the tracked candidate moving object has continued to be located in the digital video signal;
combining the respective scores of the tracked candidate moving objects to obtain an overall score for the scene; and
indicating to a user whether the overall score satisfies a predetermined criterion.

2. The method of claim 1, wherein a tracked candidate moving object is an insect.

3. The method of claim 2, wherein the insect is a honeybee.

4. The method of claim 3, wherein the overall score satisfying the predetermined criterion indicates that there is at least one foraging honeybee in the scene.

5. The method of claim 1, wherein identifying in the digital video signal one or more candidate moving objects in the scene includes:
subtracting a first video frame of the digital video signal from a second video frame of the digital video signal to produce a difference frame; and
identifying as a candidate moving object a non-zero region of the difference frame.

6. The method of claim 5, wherein locating at least one candidate moving object in the digital video signal subsequent to identification of the at least one candidate moving object includes examining, in a second difference frame subsequent to a first difference frame in which the at least one candidate moving object was located, a predetermined neighborhood surrounding a location in the second difference frame, the location in the second difference frame corresponding to a position in the first difference frame at which the at least one candidate moving object was located.

7. The method of claim 1, wherein identifying in the digital video signal one or more candidate moving objects in the scene includes:
subtracting from a video frame of the digital video signal a weighted average of a plurality of other video frames of the digital video signal to produce a difference frame; and
identifying as a candidate moving object a non-zero region of the difference frame.

8. The method of claim 7, wherein locating at least one candidate moving object in the digital video signal subsequent to identification of the at least one candidate moving object includes examining, in a second difference frame subsequent to a first difference frame in which the at least one candidate moving object was located, a predetermined neighborhood surrounding a location in the second difference frame, the location in the second difference frame corresponding to a position in the first difference frame at which the at least one candidate moving object was located.

9. The method of claim 1, wherein assigning a score to each tracked candidate moving object in accordance with how long after passage of the predetermined period the tracked candidate moving object has continued to be located in the digital video signal includes increasing the score of at least one tracked candidate moving object nonlinearly while that tracked candidate moving object continues to be located in the digital video signal.

10. The method of claim 1, wherein the predetermined criterion is that the overall score exceed a predetermined threshold and wherein indicating to a user whether the overall score satisfies the predetermined criterion includes activating at least one of a visual and an audible indicator.

11. The method of claim 1, wherein the digital video signal is acquired from a prerecorded digital video file.

12. The method of claim 1, wherein the digital video signal is acquired from a digital imaging device in real time.

13. The method of claim 12, further comprising:
displaying in real time a differential video signal including difference frames derived from the digital video signal to aid the user in aiming the digital imaging device, the differential video signal being used in identifying the candidate moving objects and in tracking the candidate moving objects that, for at least a predetermined period after they have been identified, continue to be located in the digital video signal.

14. The method of claim 13, wherein a reduced-intensity version of the scene and the differential video signal are combined in a single view.

15. The method of claim 1, further comprising:
plotting a graph of the overall score as a function of frame number in the digital video signal.

16. A system for tracking moving objects in a scene, the system comprising:
at least one processor; and
a memory containing a plurality of program instructions configured to cause the at least one processor to:
acquire a digital video signal corresponding to the scene;
identify in the digital video signal one or more candidate moving objects in the scene;
locate at least one candidate moving object in the digital video signal subsequent to identification of the at least one candidate moving object;
track candidate moving objects that, for at least a predetermined period after they have been identified, continue to be located in the digital video signal;
assign a score to each tracked candidate moving object in accordance with how long after passage of the predetermined period the tracked candidate moving object has continued to be located in the digital video signal;
combine the respective scores of the tracked candidate moving objects to obtain an overall score for the scene; and
indicate to a user whether the overall score satisfies a predetermined criterion.

17. The system of claim 16, further comprising:
a digital imaging device to generate the digital video signal;
wherein the plurality of program instructions are configured to cause the at least one processor to acquire the digital video signal from the digital imaging device in real time.

18. The system of claim 17, further comprising:
a display;
wherein the plurality of program instructions are configured to cause the at least one processor to show on the display in real time a differential video signal including difference frames derived from the digital video signal to aid the user in aiming the digital imaging device, the differential video signal being used in identifying the candidate moving objects and in tracking the candidate moving objects that, for at least a predetermined period after they have been identified, continue to be located in the digital video signal.

19. The system of claim 18, wherein the plurality of program instructions are configured to cause the at least one processor to combine, in a single view on the display, a reduced-intensity version of the scene and the differential video signal.

20. The system of claim 16, wherein the plurality of program instructions are configured to cause the at least one processor, in identifying in the digital video signal one or more candidate moving objects in the scene, to:
subtract a first video frame of the digital video signal from a second video frame of the digital video signal to produce a difference frame; and
identify as a candidate moving object a non-zero region of the difference frame.

21. The system of claim 20, wherein the plurality of program instructions are configured to cause the at least one processor, in locating at least one candidate moving object in the digital video signal subsequent to identification of the at least one candidate moving object, to examine, in a second difference frame subsequent to a first difference frame in which the at least one candidate moving object was located, a predetermined neighborhood surrounding a location in the second difference frame, the location in the second difference frame corresponding to a position in the first difference frame at which the at least one candidate moving object was located.

22. The system of claim 16, wherein the plurality of program instructions are configured to cause the at least one processor, in identifying in the digital video signal one or more candidate moving objects in the scene, to:
subtract from a video frame of the digital video signal a weighted average of a plurality of other video frames of the digital video signal to produce a difference frame; and
identify as a candidate moving object a non-zero region of the difference frame.

23. The system of claim 22, wherein the plurality of program instructions are configured to cause the at least one processor, in locating at least one candidate moving object in the digital video signal subsequent to identification of the at least one candidate moving object, to examine, in a second difference frame subsequent to a first difference frame in which the at least one candidate moving object was located, a predetermined neighborhood surrounding a location in the second difference frame, the location in the second difference frame corresponding to a position in the first difference frame at which the at least one candidate moving object was located.

24. The system of claim 16, wherein the plurality of program instructions are configured to cause the at least one processor, in assigning a score to each tracked candidate moving object in accordance with how long after passage of the predetermined period the tracked candidate moving object has continued to be located in the digital video signal, to increase the score of at least one tracked candidate moving object nonlinearly while that tracked candidate moving object continues to be located in the digital video signal.

25. A computer-readable storage medium containing a plurality of program instructions executable by a processor, the plurality of program instructions comprising:
a first instruction segment configured to cause the processor to acquire a digital video signal corresponding to the scene;
a second instruction segment configured to cause the processor to identify in the digital video signal one or more candidate moving objects in the scene;
a third instruction segment configured to cause the processor to locate at least one candidate moving object in the digital video signal subsequent to identification of the at least one candidate moving object;
a fourth instruction segment configured to cause the processor to track candidate moving objects that, for at least a predetermined period after they have been identified, continue to be located in the digital video signal;
a fifth instruction segment configured to cause the processor to assign a score to each tracked candidate moving object in accordance with how long after passage of the predetermined period the tracked candidate moving object has continued to be located in the digital video signal;
a sixth instruction segment configured to cause the processor to combine the respective scores of the tracked candidate moving objects to obtain an overall score for the scene; and
a seventh instruction segment configured to cause the processor to indicate to a user whether the overall score satisfies a predetermined criterion.
